(19) United States
(12) Patent Application Publication
(10) Pub. No.: US 2025/0087803 A1
(43) Pub. Date: Mar. 13, 2025

(54) BATTERY HOUSING ARRANGEMENT WITH A HOUSING UNIT FOR A CELL LATCH AND BATTERY ARRANGEMENT

(71) Applicant: AUDI AG, Ingolstadt (DE)

(72) Inventors: Markus THURMEIER, Adlkofen (DE); Carsten LORENZ, Reichertshofen (DE); Eduard MAIN, Buxheim (DE); Peter JURIS, Bergheim (DE); Dirk HOEFNER, Wellheim (DE); Sebastian ENDERLE, Bad Rappenau (DE)

(73) Assignee: AUDI AG, Ingolstadt (DE)

(21) Appl. No.: 18/826,774

(22) Filed: Sep. 6, 2024

(30) Foreign Application Priority Data
Sep. 8, 2023 (DE) 102023124246.6

(51) Int. Cl. H01M 50/209; H01M 10/6556; H01M 50/249; H01M 50/264

(52) U.S. Cl. CPC H01M 50/209; H01M 10/6556; H01M 50/249; H01M 50/264

(57) ABSTRACT

A battery housing arrangement with a first housing unit for accommodating at least two prismatic battery cells, which has a side wall, a first outer wall with a first wall portion, and a second outer wall opposite the first outer wall with a second wall portion, which is opposite the first wall portion, the side wall connecting the first and second outer walls to one another. The first housing unit can be reversibly coupled to a second housing unit of the same design as the first housing unit, forming a cuboid receiving space, in such a way that the side wall of the first housing unit is opposite a side wall of the second housing unit, and in that the at least two prismatic battery cells can be arranged next to one another in the receiving space.

### FIELD

The invention relates to a battery housing arrangement having a first housing unit for accommodating at least two prismatic battery cells which each have two opposing first cell sides and two opposing second cell sides, wherein the first cell sides each have a larger surface area than a respective second cell side, wherein the first housing unit has a side wall, a first outer wall with a first wall portion and a second outer wall which is opposite the first outer wall with respect to a first direction with a second wall portion which is opposite the first wall portion with respect to the first direction, wherein the side wall is arranged between the first and second outer wall with respect to the first direction, connecting them to each other and adjacent to the respective first and second wall portions. Furthermore, the invention also relates to a battery arrangement.

### BACKGROUND

Current battery systems with prismatic battery cells in modular design usually have poor scalability and require a lot of installation space for contacting the individual cells. It would therefore be desirable to have a more space-saving and more flexible arrangement option in terms of scalability.

DE 10 2021 123 312 A1 describes a battery arrangement for a motor vehicle, which comprises two battery modules, each with at least one battery cell, wherein a first battery cell is arranged in a first module housing and a second battery cell is arranged in a second module housing and wherein the two module housings are sealed off from each other. As a result, thermal propagation can be delayed longer in the event of thermal runaway of a battery cell.

CN 218 333 949 U describes a battery cell with a large capacity. The battery cell is designed as an elongated battery cell which comprises a pole on each of its opposite end faces. The battery cell also comprises a plurality of heat sinks on its two opposite sides with the largest surface area, which sinks extend perpendicular to the longitudinal direction of the battery cell.

### SUMMARY

The object of the present invention is to provide a battery housing arrangement and a battery arrangement which enable a battery to be constructed in the most space-saving and flexible manner possible.

This object is achieved by a battery housing arrangement and a battery arrangement.

A battery housing arrangement according to the invention comprises a first housing unit for accommodating at least two prismatic battery cells which each have two opposing first cell sides and two opposing second cell sides, wherein the first cell sides each have a larger surface area than a respective second cell side, wherein the first housing unit has a side wall, a first outer wall with a first wall portion and a second outer wall which is opposite the first outer wall with respect to a first direction with a second wall portion which is opposite the first wall portion with respect to the first direction. In this case, the side wall is arranged between the first and second outer walls with respect to the first direction, connecting them to one another and adjacent to the respective first and second wall portions. In addition, the first housing unit can be coupled to a second housing unit of the same design as the first housing unit, forming a cuboid receiving space, such that the side wall of the first housing unit is opposite a side wall of the second housing unit in a second direction perpendicular to the first direction and that the at least two prismatic battery cells can be arranged next to one another in the receiving space in a third direction perpendicular to the first direction such that at least two of the second cell sides of the at least two battery cells face one another.

The invention is based on several findings: Firstly, prismatic battery cells can be arranged to form a cell stack or battery module not only in such a way that their largest sides in terms of area face each other, as is usually the case, but they can also be arranged in such a way that other cell sides, which are not the largest cell sides in terms of area, face each other. The battery cells are thus arranged in a cell row that is relatively long and narrow. How many battery cells are arranged in such a row depends on the available installation space and can therefore be very flexibly dimensioned. This cell arrangement also has the great advantage that it allows the battery cells to be contacted in a particularly simple and space-efficient manner. The cell poles can be arranged on the second cell sides, for example, one cell pole per second cell side. For example, the cells can simply be interconnected in such a way that their facing cell poles contact each other directly with their flat end faces or are contacted via a cell connector. Especially with regard to the third direction defined above, this allows a particularly space-efficient arrangement of the battery cells. The invention is also based on the realization that such a cell row can be enclosed in a housing unit in a particularly space-efficient manner. Such a housing unit, such as the first housing unit, then forms, for example, an elongated cell sword or a cell latch with this cell row. Several such latches can then be arranged next to each other in the second direction and fixed to each other. This allows a particularly high degree of flexibility with regard to the scalability of this arrangement in the second direction. Depending on the available installation space, more or fewer cell latches can simply be coupled together to provide a battery, in particular a high-voltage battery for a motor vehicle. Overall, the battery housing arrangement makes it possible to achieve very good scalability of a high-voltage battery and, for example, to implement foot garages or multi-level battery systems just as easily due to this simple scalability. The installation space requirement is particularly low due to the possibility of direct or space-saving indirect contacting of the cell poles or cell terminals within such a cell latch. The resulting narrower design in the third direction allows either more space for crash structures or a narrower vehicle design.

The coupling option between the individual housing units is also preferably designed as a reversible coupling option, in particular as a non-destructive reversible coupling, e.g. as a coupling by means of latching elements for latching the housing units together and/or by means of tension straps or tie rods. The first housing unit can therefore be reversibly coupled to the second housing unit, which is the same or similar to the first housing unit, forming the cuboid receiving space, i.e. it can be decoupled from the second housing unit in a non-destructive manner. The fact that the first housing unit can be reversibly coupled to a similarly designed second housing unit is to be understood in such a way that the first housing unit can be decoupled from the second housing unit in the coupled state again in a non-destructive manner. In principle, the first housing unit and the second housing unit can also be alternately coupled and decoupled from each other several times. There are several possibilities for the coupling options, which will be explained in more detail later.

The reversible coupling option of the housing units to each other also provides a particularly advantageous repair option for individual cell rows. For example, in the event of a defect in an individual battery cell, this housing arrangement can be opened specifically in the region of the defective battery cell without affecting other cell rows. This also makes the replacement of an individual battery cell or a cell row particularly efficient and economical.

However, it is also conceivable that the housing units are not reversibly detachably coupled to each other, e.g. are welded to each other, glued or similar.

Depending on its orientation, the cell latch can also absorb forces in the longitudinal and/or transverse direction of the vehicle and also enables the transmission of forces in the z-direction, i.e. in the vertical direction of the vehicle, wherein the battery housing arrangement is preferably arranged in the motor vehicle in such a way that the first direction is aligned parallel to the vertical direction of the vehicle. Such individual cell swords designed using the battery housing arrangement can also be attached to a battery housing cover or battery housing base of an overall battery housing, for example by bonding, which can further increase the rigidity of the system.

The first outer wall, the second outer wall and the side wall are essentially plate-shaped components. Furthermore, the first outer wall is aligned essentially perpendicular to the side wall and the second outer wall is also aligned essentially perpendicular to the side wall, while the first outer wall and the second outer wall are essentially parallel to each other. As explained in more detail later, the first outer wall, the second outer wall and the side wall can, for example, form a U-profile or a double T-profile. The first outer wall, the second outer wall and the side wall extend essentially the same length in the third direction. In addition, the two outer walls and the side wall can have a single-layer or multi-layer structure. In addition, the outer walls and the side wall can basically be made of any material, for example a metallic material and/or a plastic and/or a fiber-reinforced plastic or similar. If two such housing units are coupled together as intended to form the cuboid receiving space and arranged in relation to each other, the side wall of the first housing unit is opposite the side wall of the second housing unit with respect to the second direction. The receiving space is therefore limited in the second direction by the two side walls of the two housing units. With respect to the first direction, the receiving space is delimited at least by the first wall portion and the second wall portion of the first housing unit. Optionally, a third and fourth wall portion of the second housing unit can also contribute to limiting the receiving space in the first direction, as explained in more detail later.

According to a further advantageous embodiment of the invention, the first outer wall comprises the first wall portion and/or the second outer wall comprises the second wall portion, in particular wherein the side wall forms a U-profile with the first and second wall portions. The side wall thus adjoins, for example, a first end of the first wall portion with respect to the second direction and a second end of the second wall portion, also with respect to the second direction. The first and second wall portions thus project from the side wall in the same direction and adjoin the two ends or edge regions of the side wall by which the side wall is limited in its extension in the first direction. In this case, for example, the extension of the first and second outer wall in the second direction then corresponds essentially to a width of a prismatic battery cell in this second direction, which is to be accommodated or received in the receiving space of the battery housing arrangement.

However, it is also conceivable that the side wall and the two outer walls form the shape of a double-T profile. Accordingly, it is a further advantageous embodiment of the invention if the first outer wall is divided in the second direction on the first and third wall portions and the side wall adjoins a first boundary region between the first and third wall portions, and/or the second outer wall is divided on the second and fourth wall portion, which adjoins the second wall portion in the second direction and which is opposite the third wall portion with respect to the first direction, wherein the side wall adjoins a second boundary region between the second and fourth wall portions, in particular wherein the side wall forms a double-T profile with the first and second outer walls. A single “T” of this double T-profile is formed on the one hand by the side wall and the first outer wall and the other “T” of this double T-profile is formed by the side wall and the second outer wall. In this case too, the two outer walls are perpendicular to the side wall. However, the side wall does not adjoin the two outer walls at the end, but for example in the middle or as defined above in the corresponding boundary regions. The boundary between the first and third wall portions can, for example, run in a straight line in the third direction. The side wall can run continuously adjacent to this boundary line with one end face. The same applies to the side wall and the second outer wall and their wall portions. The two wall portions of the same outer wall do not necessarily have to be the same size, at least not in relation to the second direction. The receiving space, which is formed when the first housing unit is arranged on a similar second housing unit as intended, is then bounded in the first direction on the one hand by the first and second wall portions of the first and second outer walls of the first housing unit, and also by the third and fourth wall portions of the first and second outer walls of the second housing unit. In this example, the length of the first and second outer wall, with the possible addition of the thickness of the side wall in the second direction, thus corresponds in the second direction essentially or approximately to a width of a prismatic battery cell in the second direction, if this is arranged in the receiving space as intended.

It is also conceivable to combine the designs according to the U-profile and the T-profile. For example, the first outer wall can be divided into the first and third wall portions, while the second outer wall consists only of the second wall portion, or vice versa, the first outer wall can consist only of the first wall portion, while the second outer wall is divided into the second wall portion and the fourth wall portion.

Thanks to these advantageous geometric design options for the housing units, it is possible to easily form cuboidal receiving spaces when coupling several housing units together.

According to a further advantageous embodiment of the invention, the first outer wall has a first and second coupling region, which in particular lie opposite one another with respect to the second direction, and of which at least the first coupling region is enclosed by the first wall portion, wherein the first coupling region is mechanically and in particular positively couplable to a second coupling region of the second housing unit, which is constructed in the same way as the first housing unit, in particular, wherein the second outer wall has a third and fourth coupling region, which can also lie opposite one another with respect to the second direction, and of which at least the third coupling region is enclosed by the second wall portion, wherein the third coupling region can be coupled mechanically and in particular positively to a fourth coupling region of the second housing unit designed in the same way as the first housing unit. The coupling can be provided, for example, by latching the corresponding coupling regions. The coupling regions can be designed accordingly with latching elements, for example latching lugs and corresponding recesses. The latching lugs can snap into the recesses. However, the latching elements can also be designed as saw-tooth latching elements. These can, for example, have a constant sawtooth profile in the third direction. In this way, the coupled housing units can be released from each other again by moving them relative to each other in the third direction. There are numerous other advantageous ways in which such a latching connection or clip connection or, in general, such a form-fitting connection can be implemented by the corresponding coupling regions of two similar housing units that can be brought into engagement with each other.

The first coupling region of the first wall portion can therefore be coupled to a corresponding second coupling region of the first outer wall of the second housing unit and reversibly decoupled from it again in a non-destructive manner. If the side wall and the two outer walls form a U-profile, for example, the second coupling region can also be part of the first outer wall. If these form a double T-profile, the second coupling region can accordingly be part of the third wall portion defined above. The second outer wall can be designed in the same way as described for the first wall portion. This can also be designed, for example, in such a way that the fourth coupling region is also part of the second wall portion of the second outer wall or part of the fourth wall portion defined above. As also explained above, the first and second outer walls do not necessarily have to be of the same or similar design.

In a further advantageous embodiment of the invention, the first housing unit extends in the third direction on both sides further than the receiving space. Thus, if the prismatic battery cells are accommodated in the receiving region or receiving space, the housing unit extends beyond them on both sides in the third direction. This has several advantages. Particularly if, for example, the cell terminals are arranged on the second cell sides, these cell terminals can be significantly better protected, for example in the event of a crash, by the profile ends of the housing unit projecting beyond the battery cells in the third direction. This design of the profile ends of the housing unit can thus reduce the risk of the cell terminals being stressed in a crash. In addition, this design means that forces in the third direction can be absorbed much better in the housing unit and passed through the housing unit without stressing the battery cells accommodated in the housing unit.

In a further advantageous embodiment of the invention, the battery housing arrangement has at least one second housing unit of the same design as the first housing unit, in particular the second housing unit already mentioned above. The battery housing arrangement can also comprise any number of such housing units, which are similar or identical to one another. The properties and features as explained with regard to the first housing unit can thus also apply in the same way to the second housing unit and any other optional housing unit. The housing units can, for example, form a battery housing or essentially contribute to the formation of such a battery housing. In addition, the battery housing arrangement can also have a terminal housing unit. This can also be provided, for example, only by a connection wall, which can be formed, for example, like the side wall of a housing unit, or it can be provided essentially as one half of a housing unit, for example by a housing unit without the first and second wall portions or without the third and fourth wall portions, or it can simply be provided by an end plate, in particular of a clamping device.

By means of a large number of such housing units coupled to one another, in particular in a reversibly detachable manner, a battery housing of any size can be formed in a particularly flexible manner, depending on the number of housing units, by means of which any number of cuboidal receiving regions or receiving spaces can be provided, in which cell rows with at least two prismatic battery cells can be received in each case.

In a further advantageous embodiment of the invention, the battery housing arrangement has at least one tensioning device, in particular a tensioning strap and/or a tie rod, by means of which the first and second housing units can be fixed relative to one another. If the battery housing arrangement comprises more than two housing units, all the housing units comprised by the battery housing arrangement, including the above-mentioned end plate or cover plate or also second end plates or cover plates, can be fixed to one another in the same way by means of such a tensioning device. For example, such a tensioning device can be designed as one or more tensioning straps spanning the housing units. Such tensioning straps can be made of metal, for example, or of a plastic, for example a fiber-reinforced plastic, for example a so-called UD (unidirectional) fiber tape. Such a clamping device can also be provided in addition to the coupling regions described above for positive coupling of the housing units to each other. An additional tensioning strap or an additional tensioning device has the advantage that it can provide significantly greater tensioning forces. In particular, such a clamping device can absorb swelling forces much better, such as those that occur during the charging process or over the service life of the battery cells due to swelling. If a battery cell or a cell row is to be replaced, the tensioning strap can be easily removed, the corresponding cell row opened and the battery cells removed and replaced. The tensioning device can be replaced with a new one, for example. In the case of a tie rod, this can also be reused. Such a tie rod can, for example, clamp together two pressure plates that delimit the battery housing arrangement on both sides with respect to the second direction. Such pressure plates can also be formed in one piece with the housing units arranged at the ends.

According to a further particularly advantageous embodiment of the invention, at least the side wall has at least one integrated first cooling channel through which a coolant can flow, in particular wherein the first and/or second outer wall are formed with at least one second integrated cooling channel through which a coolant can flow. The side walls and optionally also the outer walls can also comprise several cooling channels or cooling channel portions. The cooling channels surrounded by a housing unit are preferably fluidically coupled to one another. A coolant can therefore pass through the respective cooling channel portions successively. As a result, the number of required supply and discharge connections can be reduced. The fact that at least the side wall has an integrated cooling channel has the great advantage that the sides of the prismatic battery cells with the largest surface area can be cooled. The cells are arranged in the receiving space as intended in such a way that their largest sides in terms of surface area, which can be provided for example by the first cell sides of the battery cells, face the side walls of the two housing units, which delimit the receiving space in and against the second direction.

This means that a particularly large cooling surface can be provided overall, which in turn can increase performance. If the two outer walls are also designed with cooling channels, the battery cells can be cooled on almost all sides. In particular, these can then be cooled on all cell sides except for the second cell sides directly by contact with a wall of the housing units.

Optionally, the battery cells can be glued to a housing unit or both adjacent housing units in the receiving space, but this is not absolutely necessary. In particular, no gap filler or gap pad is required between the cells and the housing unit or housing units. Due to the usually high contact pressure forces that arise between the first cell sides and the side walls of the housing units, a good thermal connection between the cells and the side walls is automatically ensured.

According to a further advantageous embodiment of the invention, the first housing unit comprises a coolant supply connection and/or a coolant discharge connection. Preferably, the first housing unit comprises both a coolant supply connection and a coolant discharge connection. As a result, fluidic coupling of the housing units to one another can be avoided. This allows particularly fluid-tight and safe solutions. For example, the coolant supply and discharge connections of the same housing unit can be arranged at opposite ends of this housing unit with respect to the third direction. However, they can also be arranged at the same end of the housing unit.

Accordingly, a coolant can be supplied to the at least one cooling channel integrated in the housing unit via the coolant supply connection and, after passing through this cooling channel, the coolant can be discharged from the housing unit again via the coolant discharge connection.

Furthermore, the invention also relates to a battery arrangement with a battery housing arrangement according to the invention or one of its embodiments. The advantages described for the battery housing arrangement according to the invention and its embodiments apply in the same way to the battery arrangement according to the invention.

According to a further advantageous embodiment of the invention, the battery arrangement comprises the at least two prismatic battery cells, in particular wherein the battery cells each have two cell poles, which can also be referred to as terminals or cell terminals, and wherein precisely one of the cell poles is arranged on a respective second cell side.

This arrangement allows particularly simple and space-saving contacting of the battery cells of the same cell row with each other. For example, the contacting, i.e. the electrical interconnection of the cell poles of different cells, can be achieved by the cell poles of two battery cells that are adjacent to each other in the third direction contacting each other directly and flatly or being connected to each other via cell connectors located between these cell poles facing each other. Such a cell connector makes it easier to achieve tolerance compensation in the third direction.

In addition, the second wall portion can also have recesses or through-openings that are arranged in the first direction below corresponding venting openings of a respective battery cell. Each of the cells therefore comprises exactly one venting opening, which is arranged, for example, on a third cell side of the relevant battery cell. The third cell side faces the second wall portion. The second wall portion has a number of recesses or openings that corresponds to the number of battery cells. If outgassing occurs in one of the battery cells during a thermal runaway of this battery cell, the gas escape is facilitated by such a recess or through-opening. The escaping gas can, for example, be introduced into a gas discharge channel.

In addition, the side wall can also have a further recess or recesses on the end face with respect to the third direction for contacting the cell latches with each other. Busbars and/or cables can be routed through such recesses. This enables a particularly compact design.

Furthermore, the invention also relates to a motor vehicle with a battery arrangement according to the invention or one of its embodiments.

The battery arrangement can be designed as a high-voltage battery, for example. The battery cells can be designed as lithium-ion cells, for example. The motor vehicle can be designed as an electric vehicle.

Furthermore, the invention also relates to a motor vehicle with a battery housing arrangement according to the invention or one of its embodiments and/or a battery arrangement according to the invention or one of its embodiments.

The motor vehicle according to the invention is preferably designed as a motor car, in particular as a passenger car or truck, or as a passenger bus or motorcycle.

The invention also includes combinations of the features of the embodiments described. The invention thus also includes implementations which each have a combination of the features of several of the embodiments described, provided that the embodiments have not been described as mutually exclusive.

### BRIEF DESCRIPTION OF THE FIGURES

Examples of embodiments of the invention are described below. In particular:

FIG. 1 shows a schematic and perspective exploded view of a battery arrangement with a housing unit and a cell row according to an exemplary embodiment of the invention;

FIG. 2 shows a schematic representation of the battery arrangement of FIG. 1, wherein the cell row is now shown accommodated in the housing unit, according to an exemplary embodiment of the invention;

FIG. 3 shows a schematic cross-sectional representation of a battery arrangement with housing units designed as a C-profile or U-profile according to an exemplary embodiment of the invention;

FIG. 4 shows a schematic and perspective representation of one end of the battery arrangement of FIG. 2 according to an exemplary embodiment of the invention;

FIG. 5 shows a schematic cross-sectional representation of a battery arrangement with multiple housing units designed as double T-profiles according to a further exemplary embodiment of the invention;

FIG. 6 shows a schematic exploded view of a battery arrangement with a housing unit designed as a double-T profile and a cell row according to an exemplary embodiment of the invention;

FIG. 7 shows a schematic representation of the battery arrangement of FIG. 6 with battery cells now accommodated in the receiving region of the housing unit according to an exemplary embodiment of the invention; and

FIG. 8 shows a schematic top view of a battery arrangement designed as a high-voltage battery according to an embodiment of the invention.

### DETAILED DESCRIPTION

The exemplary embodiments described below are preferred embodiments of the invention.

In the exemplary embodiments, the described components of the embodiments each represent individual features of the invention which are to be considered independently of each other and which also further form the invention independently of each other. Therefore, the disclosure is also intended to include combinations of the features of the embodiments other than those shown. Furthermore, the described embodiments can also be supplemented by further features of the invention already described.

In the figures, identical reference numerals denote elements with the same function.

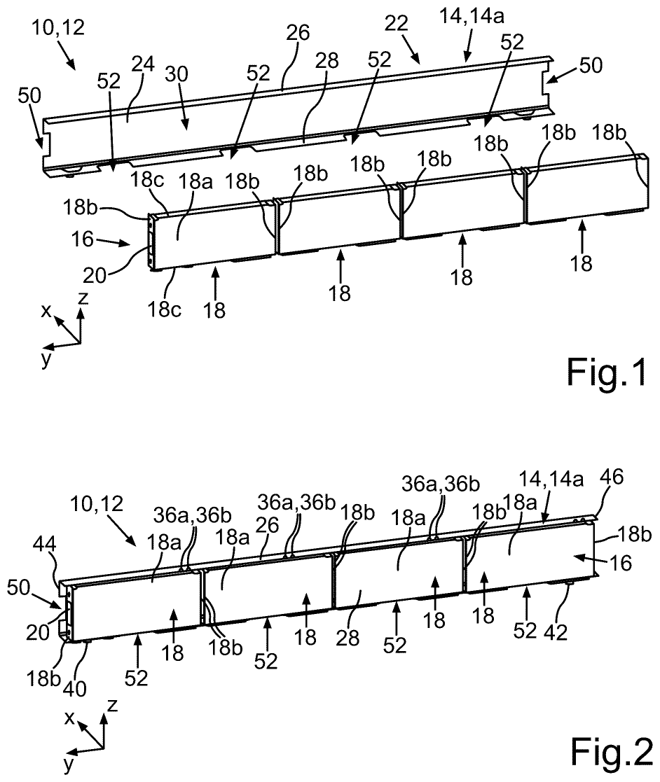

FIG. 1 shows a schematic and perspective exploded view of a battery arrangement 12 formed as a cell latch or cell sword 10 according to an exemplary embodiment of the invention. The battery arrangement 12 comprises a housing unit 14 and a cell row 16 with several prismatic battery cells 18.

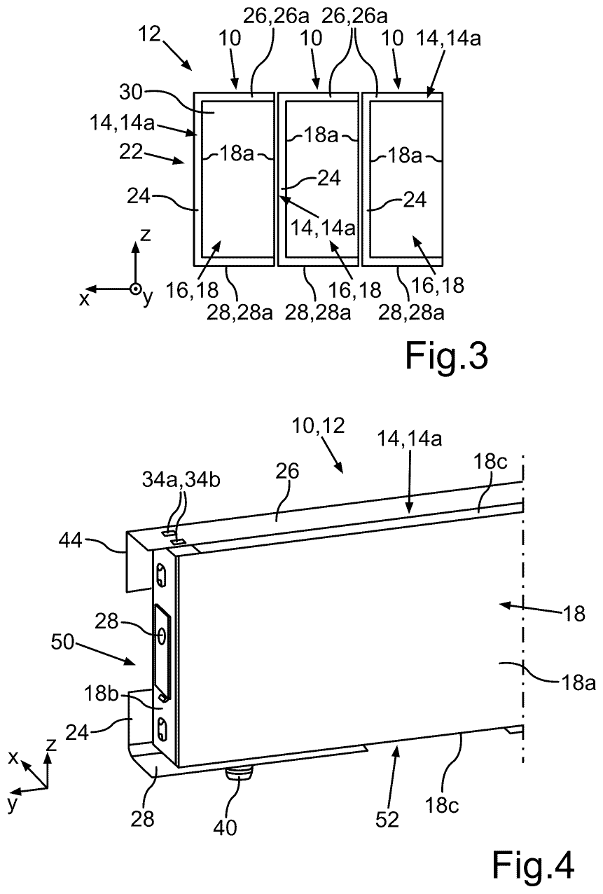

FIG. 2 again shows a schematic representation of the battery arrangement 12 in the form of the cell latch 10 in a state in which the cell row 16 is now accommodated in the receiving region or receiving space 30 (cf. FIG. 1) and FIG. 4 again shows a schematic and perspective detailed view of the battery arrangement 12 in the form of the cell latch 10 according to FIG. 2. In particular, the end of the cell latch 10 is shown enlarged once again. FIG. 3 shows a schematic cross-sectional view of a battery arrangement 12 with several such cell latches 10. FIG. 1 to FIG. 4 are therefore discussed together in part below.

The prismatic battery cells 18 of such a cell latch 10, as shown for example in FIG. 1, are all of the same design. These respectively comprise two first sides 18a, which represent the largest sides of the respective battery cells 18 in terms of surface area. Only one of these two first sides 18a can be seen per battery cell 18 in the present embodiment. The two first sides 18a of a respective battery cell are opposite each other with respect to the x-direction shown here. In addition, each battery cell 18 comprises two second cell sides 18b. These are opposite each other with respect to the y-direction shown here and in this example represent the smallest sides of a respective battery cell 18 in terms of area. In addition, each battery cell 18 can also comprise two third sides 18c, which are opposite each other with respect to the z-direction shown. Each battery cell 18 also comprises two cell poles 20, one of which is arranged on each of the second sides 18b.

The battery cells 18 are arranged in series in such a way that they are arranged next to each other in the y-direction and their second sides 18b with the cell poles or cell terminals 20 arranged on them face each other. This enables particularly simple electrical interconnection of the prismatic battery cells 18. There are various options for contacting the cell poles 20, for example bonding, for example using electrically conductive adhesive, plugging or welding. The cell terminals 20 facing each other can, for example, have direct physical and planar contact with each other and/or be electrically conductively connected to each other via a cell connector. By arranging the prismatic battery cells 18 in this way, a lot of installation space can be saved, particularly in the y-direction. In addition, this arrangement also enables particularly simple scaling of the size of the battery arrangement 12 in the x-direction, as will be described in more detail below. The housing unit 14 is provided for this purpose. This can be part of a battery housing arrangement 22. Such a battery housing arrangement 22 can optionally also comprise several such housing units 4, as illustrated in FIG. 3. The housing units 14 can then all be of the same type, in particular of the same geometric design, at least as far as their main components are concerned, which are provided by a side wall 24, a first outer wall 26 and a second outer wall 28.

FIG. 3 shows a schematic cross-sectional view of a battery arrangement 12 with several such cell latches 10, which in turn each comprise a housing unit 14 formed as a U-profile 14a. The arrangement of the individual walls of the housing unit 14 in relation to one another can be clearly seen, particularly in FIG. 3. The housing unit 14 thus comprises, as mentioned, a side wall 24 and the first outer wall 26, which has a first wall portion 26a and in this example consists of the first wall portion 26a, as well as a second outer wall 28, which is opposite the first outer wall 26 with respect to the z-direction, comprises a second wall portion 28a and in this example also consists of this second wall portion 28a, which is directly opposite the first wall portion 26a with respect to the z-direction. In particular, the first outer wall and the second outer wall 26, 28 are arranged parallel to one another. The side wall 24 connects the two outer walls 26, 28 to each other, in this example at the end. This results in the aforementioned U-profile.

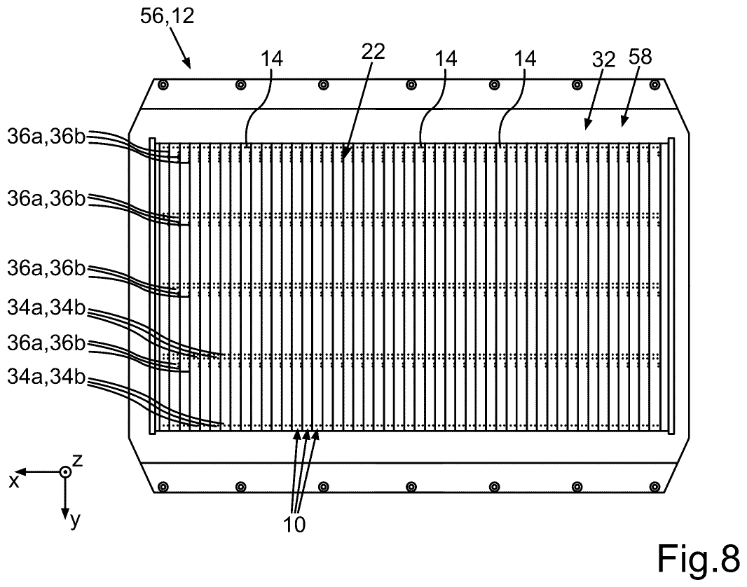

Such a housing unit 14 is now also advantageously designed to be reversibly coupled with a further housing unit 14 of the same design, forming a cuboid receiving space 30. This can also be clearly seen in FIG. 3. The individual cell swords 10 or housing units 14 can be arranged next to each other in such a way that the receiving space 30 formed in this way is bounded in one direction towards the x by a side wall 24 of the two adjacent housing units 14 and in one direction towards the z by the first and second outer walls 26, 28. A boundary in and against the y-direction does not have to be provided, in particular not by the housing units 14, and can be provided by other components, such as a battery frame 32 (see FIG. 8).

The pre-fixing or positioning of the individual battery cells 18 within such a housing unit 14 can be ensured, for example, by gluing, latching or the like. In this example, latching elements 34a, 34b are provided (see, for example, FIG. 2 and FIG. 4), via which the individual battery cells 18 can be latched to the housing unit 14. For example, the cells 18 can have cell housings with, for example, latching lugs 34a bonded to one or both third cell sides 18c. The latching elements 34a, 34b are complementary to one another and can latch into one another. In the present example, at least one of the third sides 18c of the cells 18 has such a latching element 34a, and the first outer wall 26, which is adjacent to the third side of the cell 18, has a corresponding latching element 34b. The latching elements 34a, 34b can, for example, be in the form of latching lugs and corresponding holes, recesses or indentations.

In order to connect the cell latches 10 provided in this way to one another, the housing units 14 can also be formed with coupling regions, which are only illustrated schematically in the present case. In this example, the first outer wall 26 has a first coupling region 36a and a second coupling region 36b, which can, for example, be located opposite the first coupling region with respect to the x-direction or can also be positioned differently. These coupling regions 36a, 36b are also designed as latching elements in this example. This allows the housing unit 14 to be clipped onto a similarly designed further housing unit 14 via these latching elements 36a, 36b. The first latching elements 36a snap into the latching elements 36b of the other housing unit 14. This positive connection advantageously also provides a reversible, in particular non-destructively reversible, coupling option.

Other connection or fixing options are also conceivable. For example, the battery arrangement, as shown for example in FIG. 3, can also be surrounded by a tensioning strap. Such a tensioning strap or another tensioning device can also be provided in addition to the described coupling regions 36a, 36b.

Furthermore, it is particularly advantageous if the housing unit 14 is also designed as a cooling device. For this purpose, the housing unit 14 can have at least one cooling channel through which a coolant, in particular a liquid coolant, can flow. Such a cooling channel at least preferably runs through the side wall 24 and optionally also through the two outer walls 26, 28 or at least one of the two outer walls 26, 28. The housing unit 14 can have a supply connection 40 (see FIG. 2 and FIG. 4) for supplying the coolant, and a corresponding coolant discharge connection 42 (see FIG. 2) for discharging the coolant from the housing unit 14.

FIG. 4 again shows a schematic and perspective detailed view of the end of the cell latch 10 of the battery arrangement 12. The housing unit 14 is longer in the y-direction than the cell row 16. In other words, the housing unit 14 projects beyond the cell row 16 at the end, in particular at both ends of the cell latch 10 (see also FIG. 2). As a result, both the terminals 20 and the cells 18 as a whole are set back at the end with respect to the end faces 44, 46, which are opposite each other with respect to the y-direction, of the housing unit 14. As a result, the cell terminals 20 in particular are especially well protected, as are the cells 18, especially in the event of a crash in general. For example, forces can be transmitted through the housing unit 14 in or against the y-direction. It is also possible to transmit forces via the side wall 24 in the z-direction or in the opposite direction.

Furthermore, the side wall 24 can have first recesses 50 in the region of its end faces 44, 46. Flexible printed circuit boards, busbars, i.e. conductor rails, electrical cables or the like can be passed through these recesses 50 in order to make electrically conductive contact between the cell latchs 10. These cables or electrically conductive elements passing through the recesses 50 are then also particularly well protected in the event of an impact or crash.

In addition, the housing unit 14 comprises a number of second recesses 52 corresponding to the number of cells 18. Each cell 18 has a releasable cell degassing opening on one of its third sides 18c, although this is not explicitly shown here. This is located directly opposite the second recess 52 in the second outer wall 28. Such a second recess 52 in the second outer wall 28 is thus provided for each cell 18. This facilitates the escape of gas in the event of a thermal runaway of such a cell 18.

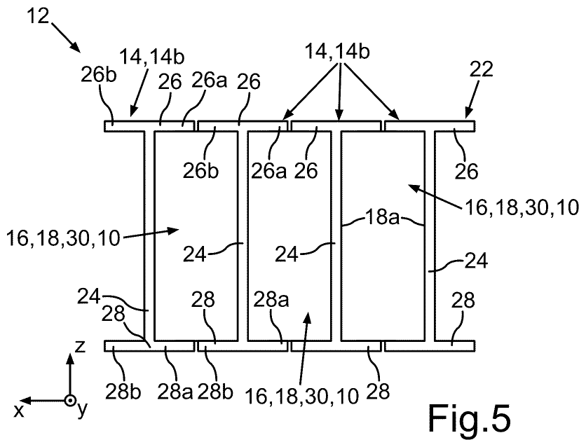

FIG. 5 shows a schematic cross-sectional representation of a battery arrangement 12 according to a further exemplary embodiment of the invention. In this example, the housing units 14 are designed in the form of double T-profiles 14b. Otherwise, the battery arrangement 12 can be designed as described above, except for the differences described below. Here too, each housing unit 14 again comprises a side wall 24 and two outer walls 26, 28. However, each outer wall 26, 28 is divided into two wall portions in the present case. The first outer wall 26 is divided into the aforementioned first wall portion 26a and a third wall portion 26b. The second outer wall 28 is divided into the second wall portion 28a and the fourth wall portion 28b. If two or more such housing units 14 of the same design are now arranged next to one another in the form of the double T-profiles 14b, as shown in FIG. 5, corresponding cuboid receiving areas 30 are again produced between each two housing units 14 arranged adjacent to one another in the x-direction.

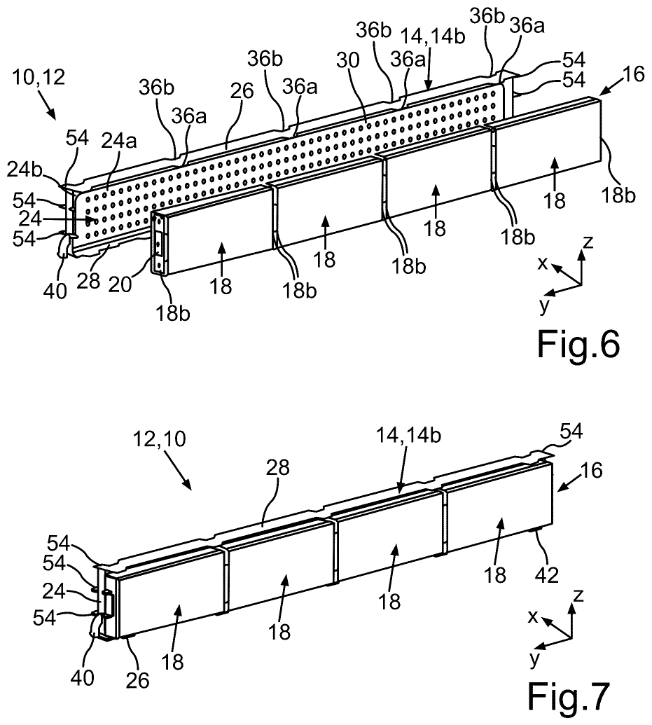

FIG. 6 shows a schematic and perspective exploded view of a battery arrangement 12, again in the form of a cell latch 10 according to a further exemplary embodiment of the invention. In this example, the housing unit 14 is designed as a double-T profile 14b, as described for example in FIG. 5. Otherwise, however, the battery arrangement 12 can be designed as described for FIG. 1 to FIG. 4.

A further difference here is that the side wall 24 is designed in multiple parts and in particular has a cooling wall 24a, which can be designed as a separate cooling unit. In addition to this separate cooling unit 24a, the side wall 24 can be designed with a main wall 24b, which is firmly arranged on or fixed to the two outer walls 26, 28 or is formed in one piece with these. The cooling wall 24a can be placed on the main wall 24b and connected to it, for example glued to it, screwed to it or similar. Accordingly, the cooling channels described above may not run in the main wall 24b, but instead in this separate cooling wall 24a. In this example, no cooling channels are integrated into the two outer walls 26, 28. The supply connection 40 is fluidically connected to this cooling wall 24a. The coolant supplied via the supply connection 40 can accordingly be introduced into the cooling channels integrated into the cooling wall 24a or the flowable volume of this cooling wall 24a and discharged again via a corresponding discharge connection 42.

FIG. 7 shows the battery arrangement 12 of FIG. 6 in a state in which the cell row 16 is now accommodated in the receiving area 30 of the housing unit 14. Here, too, it can be seen that the housing unit 14 projects beyond the cell row 16 at the end with respect to the y-direction, in particular again on both sides. The protrusion can also be realized, for example, by individual protruding webs 54.

The function of these extended webs 54 is the same as that of the profile of the housing unit 14 extended in and against the y-direction according to the example in FIG. 1 to FIG. 4.

FIG. 8 shows a schematic representation of a battery arrangement 12 designed as a high-voltage battery 56 in a plan view according to an exemplary embodiment of the invention. The battery arrangement 12 comprises a housing arrangement 22, which in turn comprises a plurality of housing units 14. These are coupled to one another and form corresponding receiving spaces 30, in which corresponding cell rows 16 are received, but which are not visible in the present case. The individual housing units 14 are latched together via latching elements 36a, 36b.

In addition, the high-voltage battery can also have a battery housing 58, which comprises, for example, a battery frame 32 and an optional base, not shown here, in which the battery arrangement 12 can be accommodated. The battery arrangement 12 can also be bonded to the battery housing 58, for example its base or its cover, which is also not shown, or also the side walls or the frame 32. The profiles, i.e. the housing units 14, can also be fluidly tight in the coupled state, e.g. by means of seals between the housing units, so that additional covers and base plates of the housing 58 are not required.

Overall, the examples show how the invention can be used to provide a cell module in latch form, in particular a cell sword.

1. A battery housing arrangement, comprising: a first housing unit for accommodating at least two prismatic battery cells which each have two opposing first cell sides and two opposing second cell sides, wherein the first cell sides each have a larger surface area than a respective second cell side, wherein the first housing unit has
a side wall,
a first outer wall with a first wall portion, and
a second outer wall which is opposite the first outer wall with respect to a first direction and has a second wall portion which is opposite the first wall portion with respect to the first direction;
wherein the side wall is arranged between the first and second outer walls with respect to the first direction, connecting them to each other and adjacent to the respective first and second wall portions,
wherein the first housing unit can be coupled to a second housing unit of the same design as the first housing unit, forming a cuboidal receiving space, in such a way that the side wall of the first housing unit is opposite a side wall of the second housing unit in a second direction perpendicular to the first direction, and in such a way that the at least two prismatic battery cells can be arranged next to one another in the receiving space in a third direction perpendicular to the first direction in such a way that at least two of the second cell sides of the at least two battery cells face one another.

2. The battery housing arrangement according to claim 1, wherein the first outer wall consists of the first wall portion, and/or the second outer wall consists of the second wall portion, in particular wherein the side wall forms a U-profile with the first and second wall portions.

3. The battery housing arrangement according to claim 1, wherein the first outer wall is divided in the second direction into the first and a third wall portion, and the side wall is adjacent to a first boundary region between the first and third wall portions, and/or the second outer wall is divided into the second and a fourth wall portion, which adjoins the second wall portion in the second direction and which is opposite the third wall portion with respect to the first direction, wherein the side wall adjoins a second boundary region between the second and fourth wall portions;
wherein the side wall forms a double-T profile with the first and second outer walls.

4. The battery housing arrangement according to claim 1, wherein the first outer wall has a first and second coupling region, of which at least the first coupling region is surrounded by the first wall portion, wherein the first coupling region can be coupled mechanically and in particular positively to a second coupling region of the second housing unit, which is identical to the first housing unit, in particular wherein the second outer wall has a third and fourth coupling region, of which at least the third coupling region is comprised by the second wall portion, wherein the third coupling region can be coupled mechanically and in particular positively to a fourth coupling region of the second housing unit, which is identical to the first housing unit.

5. The battery housing arrangement according to claim 1, wherein the first housing unit extends in the third direction on both sides further than the receiving space.

6. The battery housing arrangement according to claim 1, wherein the battery housing arrangement has at least one second housing unit of the same design as the first housing unit.

7. The battery housing arrangement according to claim 1, wherein the battery housing arrangement has at least one tensioning device, in particular a tensioning strap and/or tie rod, by means of which the first and second housing units can be fixed relative to one another.

8. The battery housing arrangement according to claim 1, wherein at least the side wall has at least one integrated first cooling channel through which a coolant can flow, in particular wherein the first and/or second outer wall are formed with at least one second, integrated cooling channel through which a coolant can flow.

9. The battery housing arrangement according to claim 1, wherein the first housing unit comprises a coolant supply connection and/or a coolant discharge connection.

10. A battery arrangement comprising a battery housing arrangement according to claim 1, wherein the battery arrangement comprises the at least two prismatic battery cells, in particular wherein the battery cells each have two cell poles, wherein precisely one of the cell poles is arranged on a respective second cell side.

11. The battery housing arrangement according to claim 2, wherein the first outer wall has a first and second coupling region, of which at least the first coupling region is surrounded by the first wall portion, wherein the first coupling region can be coupled mechanically and in particular positively to a second coupling region of the second housing unit, which is identical to the first housing unit, in particular wherein the second outer wall has a third and fourth coupling region, of which at least the third coupling region is comprised by the second wall portion, wherein the third coupling region can be coupled mechanically and in particular positively to a fourth coupling region of the second housing unit, which is identical to the first housing unit.

12. The battery housing arrangement according to claim 3, wherein the first outer wall has a first and second coupling region, of which at least the first coupling region is surrounded by the first wall portion, wherein the first coupling region can be coupled mechanically and in particular positively to a second coupling region of the second housing unit, which is identical to the first housing unit, in particular wherein the second outer wall has a third and fourth coupling region, of which at least the third coupling region is comprised by the second wall portion, wherein the third coupling region can be coupled mechanically and in particular positively to a fourth coupling region of the second housing unit, which is identical to the first housing unit.

13. The battery housing arrangement according to claim 2, wherein the first housing unit extends in the third direction on both sides further than the receiving space.

14. The battery housing arrangement according to claim 3, wherein the first housing unit extends in the third direction on both sides further than the receiving space.

15. The battery housing arrangement according to claim 4, wherein the first housing unit extends in the third direction on both sides further than the receiving space.

16. The battery housing arrangement according to claim 2, wherein the battery housing arrangement has at least one second housing unit of the same design as the first housing unit.

17. The battery housing arrangement according to claim 3, wherein the battery housing arrangement has at least one second housing unit of the same design as the first housing unit.

18. The battery housing arrangement according to claim 4, wherein the battery housing arrangement has at least one second housing unit of the same design as the first housing unit.

19. The battery housing arrangement according to claim 5, wherein the battery housing arrangement has at least one second housing unit of the same design as the first housing unit.

20. The battery housing arrangement according to claim 2, wherein the battery housing arrangement has at least one tensioning device, in particular a tensioning strap and/or tie rod, by means of which the first and second housing units can be fixed relative to one another.
